(19) United States
(12) Patent Application Publication
(10) Pub. No.: US 2008/0262965 A1
(43) Pub. Date: Oct. 23, 2008

(54) SYSTEM AND METHOD FOR PROCESSING PAYMENT OF PROPERTY TAXES BETWEEN MULTIPLE PAYORS AND MULTIPLE MUNICIPALITIES

(76) Inventor: Niko Spyridonos, Chicago, IL (US)

Correspondence Address: GREENBERG TRAURIG, LLP, 77 WEST WACKER DRIVE, SUITE 2500, CHICAGO, IL, 60601-1732, US

(21) Appl. No.: 12/047,768

(22) Filed: Mar. 13, 2008

Related U.S. Application Data
(60) Provisional application No. 60/919,576, filed on Mar. 23, 2007.

(51) Int. Cl. G06Q 20/00

(52) U.S. Cl. 705/39; 705/35

(57) ABSTRACT

A centralized computing system receives a payor data file that comprises records having data for property taxes owed by a payor to all of multiple municipalities and to receive a municipality data file from each of the multiple municipalities that comprises records having data for property taxes owed to the municipality by the payor. Included within each of the records of the payor data file is data that identifies a given one of the multiple municipalities and the centralized computer system uses this data to parse the payor data file into multiple parsed data files—each corresponding to one of the multiple municipalities. Each of the multiple parsed data files is then validated and corrected as appropriate considering the data within its corresponding one of the municipality data files. As the data within the records of each of the multiple parsed data files is determined to be valid, the system functions to issue notification that the property taxes may be paid

### BACKGROUND

The following relates generally to computer networks and, more particularly, relates to a system and method for processing payment of property taxes between multiple payors and multiple municipalities.

In the United States, governments typically rely upon property taxes assessed on real estate as a significant source of operating revenue, i.e., to fund municipal budgets for school systems, sewers, parks, libraries, fire stations, hospitals, etc. To this end, property taxes are usually assessed by local governments, typically at the level of a town, city, county, etc. (referred to hereinafter as “municipalities”), and the amount of property tax to be paid by the owner of real estate is based upon an assessed value of the real property, i.e., a determined value of the land and, if any, building(s) on the land. The assessed value of the real property is generally determined by a tax assessor, who may be a public official or a private entity retained by a municipality to provide the property value determination which is then adopted by the municipality for tax purposes.

A property tax is generally made up of two components, the assessed value of the real estate as determined by the tax assessor and the tax rate. The tax rate is typically arrived by determining a budget at the municipal level, e.g., a process in which a municipality determines how monies will be collected and distributed, and then dividing the budget by the assessment role of the municipality. Upon arriving at a tax rate, equalization is then typically considered by a board of equalizers to assure fair treatment amongst tax payers. Property assessments may therefore be given at 100 percent of the assessed value or at some lesser percentage of the assessed value of the real property. In most cases the assessed value of the real property is subject to some from of administrative review and often an appeal may be instituted by the property owner to object to what they may believe is an improper assessment. In this manner, once the tax rate is determined, a tax authority of the municipality levies the tax which, as noted above, is the tax rate multiplied by the assessed value of the real property.

To facilitate the payment of property taxes to the tax offices of the appropriate municipality, individual properties are typically given unique parcel identifiers by the municipality, i.e., property identification numbers (“PINs”). Furthermore, a tax map may be used by the municipality to administer a tax roll to thereby ensure that no properties are omitted from the tax rolls and that no properties are taxed more than once. Real property taxes are then paid by the owner of the real estate to the municipality using the appropriate PIN.

As a further means to facilitate collection of property taxes, the municipality in which the real estate is located will typically send to each property owner one or more property tax bills throughout the course of a year. Property tax bills are typically sent by U.S. mail to the owner of record at an address provided, which may or may not correspond to the address of the real estate located within the municipality. For example, real estate that is owned in trust will typically have property tax bills sent to the attention of a trustee, as opposed to the beneficial owner of the real estate. In the event that a property owner fails to pay property taxes as required, the failure will ultimately result in the property being sold by the municipality for back taxes, with the owner thereby losing their ownership interest therein.

In many instances, financial institutions take responsibility for paying property taxes to a municipality for property located in the municipality and for which the institution has loaned money to the owner of the property, such as where property is collateral for a residential mortgage or otherwise. To this end, mortgagees are often required to “escrow their taxes” whereupon the borrower pays to the financial institution on a monthly basis a pro rata share of the property taxes owed to a municipality. The financial institution, in turn, pays the property tax bill using the funds that have been paid into escrow by the borrower.

The payment and processing of property taxes is somewhat uncomplicated where the actual owner of the property is paying the tax bill by mailing a check to the treasurer's office of the municipality, together with the stub or portion of the tax bill identifying the property by its PIN. The municipality will then typically process the payment and make an indication within their records of the amount paid, the PIN, and the date upon which payment was made. However, in the case of a financial institution, such institutions typically remit to a municipality a lump sum payment for each and every one of the parcels of property located within the municipality for which the financial institution is responsible for making payment pursuant to a loan and/or other agreement between the financial institution and property owners. In this form of transaction, the financial institution typically remits the single lump sum payment together with a computerized record, such as stored on a disk or data tape of the type specified by the municipality, containing the relevant information pertaining to each property as is required for the municipality to process the payment and apportion the total payment amongst all of the properties within the municipality for which the bank is remitting payment. Thus, since a given financial institution is often responsible for remitting payment to many different municipalities, inasmuch as they typically have loaned money to borrowers securing the purchase of land located in many different municipalities, and since a given municipality typically receives payment from many different financial institutions, each of whom has similarly remitted payment for land located within the municipality, it will be appreciated that this process for paying property taxes is time consuming, complex, and fraught with error.

The current process for administering property tax payments between financial institutions and municipalities typically involves an exchange of computer data and exception reports between the financial institutions and the municipalities. In a typical case, the exchange of data from a financial institution and a municipality is done through an electronic data transfer. The process typically begins with a financial institution transmitting to the municipality a computer tape containing a data record set which functions to indicate properties for which it intends to remit property tax payments. Each data record in the data record set includes a number of fields that is specified by the municipality, and its data processing systems, including, for example, the identification of the PIN, the owner of record, information regarding exemptions, and other details specified by the municipality. Since this part of the process is repeated by the financial institution for each municipality for which it is responsible for making payments, a financial institution, at a threshold, must parse its existing data records over all of the properties for which it is obligated to make tax payments into distinct data sets corresponding to each distinct municipality to which payments are owed. Moreover, the financial institution is required to format/modify the parsed data sets in a number of different ways in order to comply with the requirements of each of the multiple, different municipality to which payments are owed. For example, one municipality may require four distinct fields as part of each record of a data set while another municipality may require five distinct fields as part of each record of a data set.

Once the data is parsed and appropriately formatted by a financial institution, a tape of the parsed and formatted data set is provided to its corresponding municipality by the financial institution and the municipality will, in turn, enter that tape into its data processing system and analyze the received data set to thereby generate a new data set, for example, by adding to the information provided by the financial institution data such as the total amount of property tax due for each PIN, an identification of any errors or exceptions, etc. For example, an error or exception may include identification of PINs found in a received data set which do not correspond to PINs within records of the municipality. This and many other types of inconsistencies may all be identified in an error report. The financial institution must then, in turn, examine the data set returned from the municipality, identify the errors, correct the errors in its data set, and provide a new, corrected data set to the municipality where the procedures described above are again repeated. Thus, since the process typically requires the repeated physical transmission of tapes or other physical media containing the data before the process is completed with the correct payment of the property taxes, it will be appreciated that the currently utilized process is undesirable for the reasons noted above, e.g., it is time consuming, complex, and fraught with error.

Accordingly, it is an objective of the present invention to provide an improved system for processing payment of property taxes between multiple payors and multiple municipalities.

### SUMMARY

To meet this objective, described hereinafter is a system and method for processing payment of property taxes between multiple payors and multiple municipalities. Generally, the described system and method utilizes a centralized computing system to receive a payor data file that comprises records having data for property taxes owed by the payor to all of the multiple municipalities and to receive a municipality data file from each of the multiple municipalities that comprises records having data for property taxes owed to the municipality by the payor. Included within each of the records of the payor data file is data that identifies a given one of the multiple municipalities and the centralized computer system uses this data to parse the payor data file into multiple parsed data files—each corresponding to one of the multiple municipalities. Each of the multiple parsed data files is then validated and corrected as appropriate considering the data within its corresponding one of the municipality data files and, as the data within the records of each of the multiple parsed data files is determined to be valid, the system functions to issue notification that the property taxes may be paid.

A better understanding of the objects, advantages, features, properties and relationships of the system and method will be obtained from the following detailed description and accompanying drawing which sets forth illustrative embodiments which are indicative of the various ways in which the principles of the system and method may be employed.

### BRIEF DESCRIPTION OF THE DRAWINGS

For a better understanding of the described system and method for processing payment of property taxes between multiple payors and multiple municipalities reference may be had to preferred embodiments shown in the following drawings in which:

FIG. 1 is a block diagram illustrating an exemplary system for processing payment of property taxes between multiple payors and multiple municipalities; and

FIG. 2 is a flow chart diagram illustrating an exemplary method for processing payment of property taxes between multiple payors and multiple municipalities.

### DETAILED DESCRIPTION

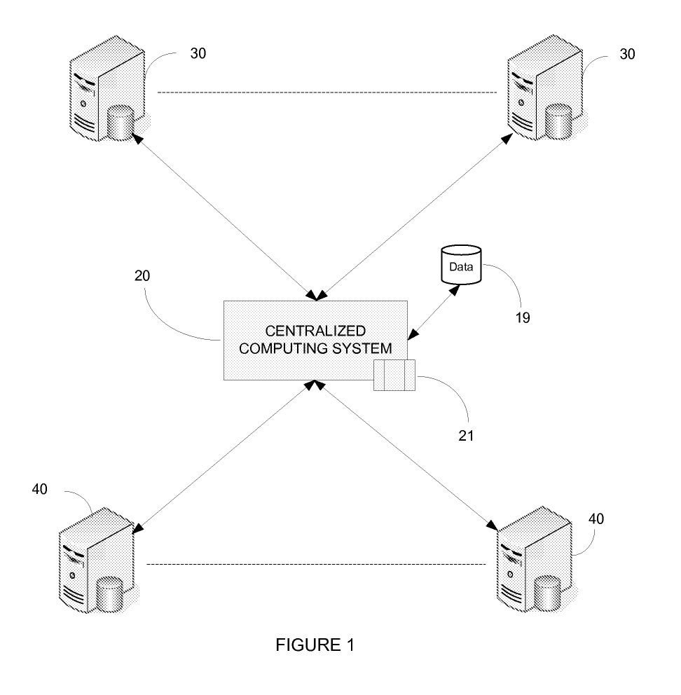

Referring now to figures, a system and method for processing payment of property taxes between multiple payors and multiple municipalities is hereinafter described. To this end, as illustrated in FIG. 1, a centralized computing system 20 is provided as a data interchange between computing systems 40 of each of a plurality of municipalities and computing systems 30 of each of a plurality of payors of property taxes, such as financial institutions seeking to make bulk payment of property taxes for real estate located within a given one or more of the municipalities.

To facilitate data interchange between the various computing systems, each municipality preferably establishes its own account with the centralized computing system 20. By allowing each municipality to establish its own account, each municipality will create its own space on the centralized computing system 20 and will thus be able to specify the manner in which it wishes data to be posted to the centralized computing system 20 and retrieved from the centralized computing system 20. To this end, each municipality is provided with the ability to specify as part of its account those fields within a data record for which it wishes to receive data, the order in which those fields are to appear within a data record, the size of each data field within a data record, and a format of the data posted in each field of each record. In so doing, each municipality can rely upon the format and structure of its own internal database system and is thereby assured that data downloaded to its computing system 40 from the centralized computing system 20 will be in a known and predicted format and will comply with the specifications initially established by the municipality. Within its account each municipality may further define exceptions for property tax payments, including the nature of the property (e.g., rural, farmland, etc.), whether payment is being made by a particular entity (e.g., a military member, a senior citizen, etc.), and the like. Still further, within its account each municipality may identify and specify dates for installment payments and any other particulars relating to the input or output of data to and from the centralized computing system 20.

Within its account each municipality may additionally specifies those financial institutions, i.e., payors, that are authorized to use the space of the municipality. To this end, a municipality may establish a separate registration protocol which is to be followed by every financial institution that wishes to make property tax payments for property taxes with that municipality via the centralized computing system 20. For example, a financial institution wishing to use the centralized computing system 20 to process property taxes for a municipality may be required to obtain their own account and password, issued by the municipality or a system administrator, agree to a subscriber set of terms and conditions, and even potentially remit a fee for the privilege of using the centralized computing system 20 for this purpose. In this manner, a municipality is able to control and, further, have prior knowledge of all payors making bulk payments for property taxes. In addition, by registering with the centralized computing system 20, each financial institution will be able to establish their own account information for purposes of security and otherwise establishing their own communication protocols and data formats for interacting with the centralized computing system 20.

For the purpose of eliminating the repetitive, time-consuming, and expensive process of exchanging multiple data tapes between multiple banks and multiple municipalities, the subject system proposes that all property tax related data is posted to and download from the centralized computer system 20 server and, moreover, proposes that the final download of data and payment of property taxes takes place at a time that the users of the system determine that the data set records are complete and payment is to be executed.

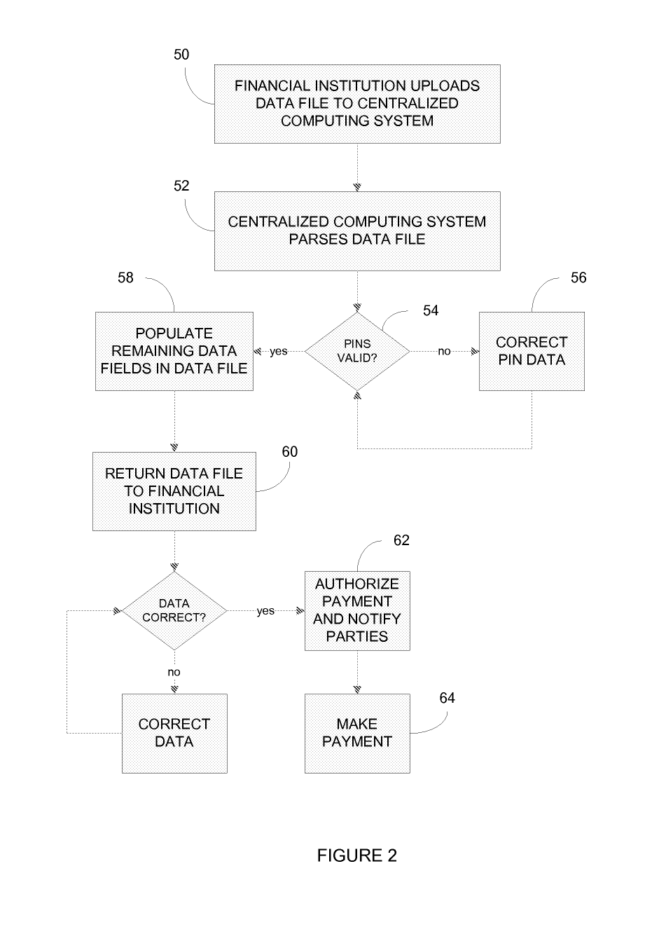

As illustrated more particularly in FIG. 2, the processing of property taxes may begin with a financial institution uploading 50 to the centralized computing system 20 a single data file that uses a single, standard specification for data. Preferably the single, standard specification for data provides that the data file includes all of the data fields that may be required by any of the municipalities who have established account spaces on the centralized computing system 20—in essence, comprising a least common denominator of data. A financial institution is thus relieved of the obligation or requirement to parse its data on a municipality by municipality basis and, instead, need only transmit to the centralized computing system 20 the single data file in which one of the data fields in the payment data records will function to identify the municipality to which property tax payments are to be made. In this manner, upon receiving the initially transmitted data file from a financial institution, the centralized computing system 20 may use the data in the appropriate data field to thereby parse 52 the data into the individual municipality account spaces.

When a data file received from the computer system 30 of a financial institution is parsed by the centralized computing system 20 to thereby create data record sets appropriate for each of the various municipalities, it is envisioned that some data fields from every record of a given data file will be common for all municipalities. For example, all municipalities will use some form of a property identification number or PIN. However, the centralized computing system 20 further automatically adapts and recognizes that there are certain fields within a received data record that are used by some municipalities but not others. Nevertheless, according to the standard file formatting instructions provided to the financial institutions upon subscribing to the system, it is assured that their data records will, in fact, include at least the data required to satisfy the requirements of each of the municipalities to which it seeks to make payments.

By way of further example, a data file that is initially uploaded by the computing system 30 of a financial institution to the centralized server system 20, while having many different fields, may includes records in which only the PIN data field is populated. The centralized computing system 20 may then match the data within the PIN data field of the records against a master data file 19 (created from one or more data files provided by the computing systems 40 of the municipalities) that is stored in association with the centralized computing system 20 to first identify and provide an accurate identification of all of the PINS located or corresponding to real property located within a municipality. In this manner, as a first check, any invalid PINs may be flagged 54 and the financial institution so notified.

To create the master data file 19, each municipality may upload to the centralized computing system 20 a data file containing a record for every property identification number corresponding to real estate located within the municipality for which it expects to receive property tax payments. The data fields will typically include the PIN, the amount of tax due, as well as other data, which may vary from municipality to municipality, including, for example but not limited to, a street address identifying the location of the property, whether installments are due, the number of installment, any outstanding interest due, and other data relevant to the county's processing of property tax payments according to its established protocol.

In the event that it is determined that an invalid or erroneous PIN has been included within a data file provided by a financial institution, the financial institution may be provided with the ability to log into the centralized computing system 20 and view the automatically generated exception report wherein any invalid/unrecognized/missing PINs are identified to the financial institution. The financial institution may then correct 56 its initially provided data file by, for example, by simply modifying the data at the centralized computing system 20 or by uploading to the centralized computing system 20 a fresh set of data. Upon a change in data, the centralized computing system 20 may again check the data validity and, if necessary, generate a new exception report. If, however, the PIN numbers within the data set is determined to be corrected, the centralized computing system 20 may proceed to populate 58 the balance of certain of the remaining fields within the data records for each property using data obtained from the master file 19. For example, once all of the PINs are deemed correct by the parties, the centralized computing system 20 may complete the blank fields within the data records using data supplied by the municipality including, but maybe not limited to, the tax due and any outstanding interest owed.

By way of more particular example, the exception report may hypothetically identify a number of PINs set forth in a payor's data record which are not recognized by the municipality, i.e., they do not appear within the data record provided by the municipality. Such errors can arise through a typographical error created when the data was first populated by a clerk at the financial institution or through other anomalies. Through the error report, the financial institution is able to review those unrecognized PINs and make an appropriate correction. Moreover, the exception report may additionally identify PINs which the financial institution does not recognize, which may result from another form of error. The financial institution is thus able to review, analyze and make any necessary corrections, alone or with the cooperation of the municipality, to the baseline data comprising PINs. For example, the bank may learn that it is attempting to make a property tax payment for a property for which it is no longer obligated to make payment, or for which payment has, for some reason, already been made.

Once the centralized computing system 20 completes the data population of the data records as described above, the centralized computing system 20 returns the data file to the financial institution 60 which is then, in turn, able to review the completed data file, including the individual property tax amounts due the municipality and the total bulk payment due. If any errors are uncovered by the financial institution the errors may be corrected as described above using appropriate error reporting via the centralized computing system 20. If the financial institution is satisfied that the records are correct and that the amount to be paid is correct, the financial institution is able to transmit a command to the centralized computing system 20 to thereby identify the data as being “ready to pay” 62. At this point, the data file is blocked, such that no further changes to the data file may be made, and the total amount due to make bulk payment is calculated by the system and made known to both the financial institution and the municipality, and a signal command or other communication may be generated by the centralized computing system 20 to the municipality indicating that the data record for that particular financial institution is ready to be transmitted and payment is to be made 64. The system then permits the financial institution and the municipality to coordinate payment in any one of a number of manners, including on a pre-determined schedule, upon command by the financial institution, or upon command by the municipality, whereupon the data exchange occurs in a known, controlled and anticipated manner. For example, to effect payment the financial institution may transmit to the municipality the bulk payment for all of the property taxes identified in the data file. It is also contemplated that, to maximize the benefit of the present system and/or to provide other incentives, the municipalities and financial institutions may agree that payments are to be made using wire transfer mechanisms and/or other automatic fund transfer mechanisms.

It is additionally contemplated that the centralized computing system 20 may incorporate a late fee logic module 21 which would be implemented by the municipality during its initial account set-up. In such a module, the municipality is able to establish and identify its late fee protocols. According to the prior art, a municipality assesses late fees against property owners on a property by property basis. According to the present use of the present module, the centralized computer system 20, having been provided with the municipality's late fee protocol, is able to assess the appropriate late fees, including interest and penalties, as specified by the municipality.

As will be appreciated from the foregoing, the described system and method has the advantage of allowing multiple financial institutions to utilize a single, known, unified manner in order to process payments to multiple municipalities without having to adapt to each municipality's specific data processing system. In addition, the described system and method has the advantage of generating conflict reports which function to identify missing or conflicting data prior to any actual exchange of data between the computing systems 30 of the financial institutions and the computing systems 40 of the municipalities.

While specific embodiments of the invention have been described in detail, it will be appreciated by those skilled in the art that various modifications and alternatives to those details could be developed in light of the overall teachings of the disclosure. For example, it will be appreciated that access to and communications between the various systems may be secured using utilities provided by the system, passwords and other security measurers, encryption, etc. without limitation. Still further, it will be appreciated that the system may provide for dynamic exporting and data warehousing. Yet further, it will be appreciated that the system may support dynamic definition of data transmission protocols. Accordingly, the particular arrangements disclosed are meant to be illustrative only and not limiting as to the scope of the invention which is to be given the full breadth of the appended claims and any equivalents thereof.

What is claimed is:

1. A method for processing payment of property taxes between a payor and multiple municipalities, comprising:
receiving at a centralized computing system a data file transmitted from the payor, the payor data file using a standardized format such that the payor data file comprises records for property taxes owed to each of the multiple municipalities by the payor and each record comprises at least those data fields that are required by each of the multiple municipalities and a first data field having data indicative of one of the multiple municipalities;
receiving at the centralized computing system a data file transmitted from each of the multiple municipalities wherein each municipality data file comprises records for property taxes owed to that municipality by the payor and each record comprises data fields having data pertaining to property taxes owed to that municipality by the payor;
using at the centralized computing system the data indicative of one of the multiple municipalities in the first data field of each of the records of the payor data file to parse the payor data file into multiple parsed data files wherein each of the multiple parsed data files comprises those records of the payor data file that are appropriate for a corresponding one of the multiple municipalities;
performing steps to validate and correct as appropriate the data within the records of each of the multiple parsed data files considering the data within the records of its corresponding one of the municipality data files; and
as the data within the records of each of the multiple parsed data files is determined to be valid, issuing notification that the property taxes may be paid.

2. The method as recited in claim 1, wherein the records of the payor data file include a second data field having data indicative of a property identification number and the steps to validate and correct as appropriate the data within the records of each of the multiple parsed data files comprises validating and correcting as appropriate the data indicative of the property identification number within the second data field of each record of each of the multiple parsed data file considering the data within the records of its corresponding one of the municipality data files.

3. The method as recited in 2, comprising populating additional data fields of each record of each of the multiple parsed data file using data from the records of its corresponding one of the municipality data files and wherein the steps to validate and correct as appropriate the data within the records of each of the multiple parsed data files comprises validating and correcting the data used in populating the additional data fields of each record of each of the multiple parsed data files.

4. The method as recited in claim 1, comprising securely transmitting the payor data file and the multiple municipality data files to the centralized computing system.

5. The method as recited in claim 1, wherein the steps to validate and correct as appropriate the data within the records of each of the multiple parsed data files comprises validating a lump sum property tax payment owed to a one of the multiple municipalities corresponding to a one of the multiple parsed data files being validated and corrected.

6. The method as recited in claim 5, comprising causing the lump sum property tax payment to be made via a wire transfer.

7. The method as recited in claim 5, comprising considering late fees when validating the lump sum property tax payment owed to the one of the multiple municipalities corresponding to the one of the multiple parsed data files being validated and corrected.

8. A system for processing payment of property taxes between a payor and multiple municipalities, comprising:
a centralized computing system which functions to receive a payor data file transmitted from a payor computing system wherein the payor data file uses a standardized format such that the payor data file comprises records for property taxes owed to each of the multiple municipalities by the payor and each record comprises at least those data fields that are required by each of the multiple municipalities and a first data field having data indicative of one of the multiple municipalities; to receive from multiple municipality computing systems a municipality data file wherein each of the multiple municipality data files comprises records for property taxes owed to that municipality by the payor and each record comprises data fields having data pertaining to property taxes owed to that municipality by the payor; to use the data indicative of one of the multiple municipalities in the first data field of each of the records of the payor data file to parse the payor data file into multiple parsed data files wherein each of the multiple parsed data files comprises those records of the payor data file that are appropriate for a corresponding one of the multiple municipalities; to cooperate with at least the payor computing system to validate and correct as appropriate the data within the records of each of the multiple parsed data files considering the data within the records of its corresponding one of the municipality data files; and, as the data within the records of each of the multiple parsed data files is determined to be valid, to issue notification that the property taxes may be paid.

9. The system as recited in claim 8, wherein the records of the payor data file include a second data field having data indicative of a property identification number and wherein the cooperation between the centralized computing system and at least the payor computing system functions to validate and correct as appropriate the data indicative of the property identification number within the second data field of each record of each of the multiple parsed data file considering the data within the records of its corresponding one of the municipality data files.

10. The system as recited in 9, wherein the centralized computing system functions to populate additional data fields of each record of each of the multiple parsed data file using data from the records of its corresponding one of the municipality data files and wherein the cooperation between the centralized computing system and at least the payor computing system functions to validate and correct as appropriate the data used in populating the additional data fields of each record of each of the multiple parsed data files.

11. The system as recited in claim 8, wherein the centralized computing system provides secure transmissions with the payor computing system and each of the municipality computing systems.

12. The system as recited in claim 8, wherein the cooperation between the centralized computing system and at least the payor computing system functions to validate and correct as appropriate a lump sum property tax payment owed to a one of the multiple municipalities corresponding to a one of the multiple parsed data files being validated and corrected.

13. The system as recited in claim 12, wherein the centralized computing system functions to cause the lump sum property tax payment to be made via a wire transfer.

14. The system as recited in claim 12, wherein the centralized computing system functions to consider late fees when validating the lump sum property tax payment owed to the one of the multiple municipalities corresponding to the one of the multiple parsed data files being validated and corrected.
